(19) United States
(12) Patent Application Publication
(10) Pub. No.: US 2010/0268735 A1
(43) Pub. Date: Oct. 21, 2010

(54) ONLINE CONTENT SERVICE WITH CATALOG-BASED INTERACTION

(75) Inventors: Christophe Planty, Paris (FR); Sylvain Biancardini, Paris (FR); Eric Guyard, Argenteuil (FR)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/425,738

(22) Filed: Apr. 17, 2009

(51) Int. Cl. G06F 15/16; G06F 17/30

(52) U.S. Cl. 707/770; 709/203; 707/E17.014

(57) ABSTRACT

An online content system is provided, including a plurality of user accounts maintained at a network-accessible online service, where associated with each user account are a plurality of content items. A catalog service is operable to provide offline metadata for the plurality of user accounts, whereby, for the plurality of content items in each of the plurality of user accounts, (a) a catalog engine of the catalog service is operable to generate a hierarchical tree descriptor for the plurality of content items, and (b) a service interface of the catalog service is operable to cause network transmission of the hierarchical tree descriptor to a remote device associated with the user account, such network transmission being independent of content item downloads to the remote device.

### BACKGROUND

Digital media can be played on portable devices configured to store, organize and playback digital music, video, games, ringtones and the like. Such digital media may also be downloaded to a portable device from an online media service via a network. However, such transmission is oftentimes network-intensive.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Accordingly, the present description provides a content system, including a plurality of user accounts maintained at a network-accessible online service, where a plurality of content items (e.g., music tracks) are associated with each user account. A catalog service is operable to provide offline metadata for the plurality of user accounts, whereby, for the plurality of content items in each of the plurality of user accounts, (a) a catalog engine of the catalog service is operable to generate a hierarchical tree descriptor for the plurality of content items, and (b) a service interface of the catalog service is operable to cause network transmission of the hierarchical tree descriptor to a remote device associated with the user account. In many of the examples discussed herein, the network transmission of the hierarchical tree descriptor is independent of content item downloads to the remote device.

### BRIEF DESCRIPTION OF THE DRAWINGS

FIG. 1 shows a schematic depiction of an embodiment of a digital content system.

FIG. 2 shows a flow diagram of an embodiment of a method of operating an online music service associated with a plurality of user accounts.

FIG. 3 shows a schematic depiction of creation and transmission of a hierarchical tree descriptor.

### DETAILED DESCRIPTION

Digital media such as music may be stored at an online service. In some cases, such media may be associated with a user account of that online service. As discussed above, transmission of such media from the online service to a user's portable device via a network can be network-intensive. Accordingly, the systems and methods disclosed herein provide an approach for generating and distributing metadata associated with the media.

The metadata may be structured to facilitate, upon receipt by a remote device, local use of the metadata, for example to provide search functionality. In many cases, the metadata will be structured hierarchically based on the categories of available metadata (for example, artist, album and song title metadata for music files). Such a hierarchical structure can enhance the user's ability to search the media and have an organized view of media files available in the user's account.

Regardless of the particular way in which the metadata is organized and used, it typically is selected and provided so that it is usable at the remote location (e.g., the portable device) independent of downloading any actual media, and independent of a network connection to the service. In other words, and for example, the metadata is typically useful to the user before they have downloaded the actual files that are described by the metadata. The separation of the metadata from the underlying files, and the efficient distribution of the metadata, allows for a networked content system that efficiently minimizes service/device communications.

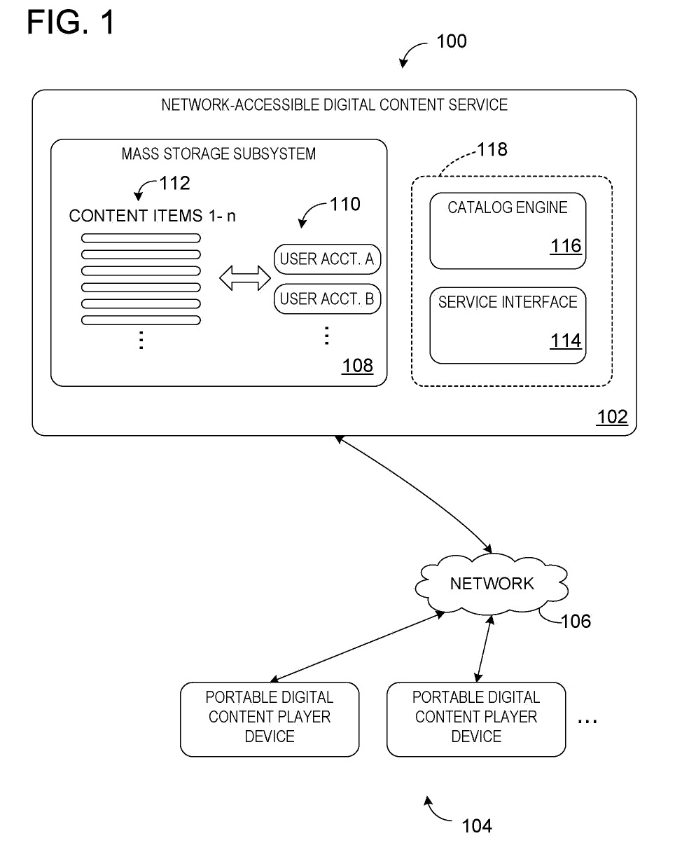

FIG. 1 schematically shows an embodiment of such a digital content system 100 comprising a network-accessible digital content service 102 configured to interact with a plurality of remote devices, such as portable digital content player devices 104, via a network 106. Portable digital content player devices 104 may include one or more mobile phones, desktop computers, laptops, portable digital assistants, etc. Network-accessible digital content service 102 may include a mass storage subsystem 108 containing a plurality of user accounts 110. Mass storage subsystem 108 may further include a plurality of digital content items 112 that are associated with each of the plurality of user accounts 110. As described above, such digital content items may include digital music, video, games, ringtones and the like. Network-accessible digital content service 102 may further include a service interface 114 configured to control communications occurring between the network-accessible digital content service 102 and portable digital content player devices 104 which are variously associated with the plurality of user accounts.

Each device may be associated with one of the plurality of user accounts in any suitable manner. As an example, a user may set up a user account at the network-accessible digital content service via a web browser. Upon setting up the user account, the user may then associate the user account with a plurality of digital content items. Such digital content items may include items purchased from an online store and/or items uploaded by the user. The user may then associate the portable device with the user account by providing their account information to the device, for example a username and password. In some cases, a user may register their device with the service, allowing the service to establish an association between the device and the user account. In some cases, an application on the device may facilitate establishing an association between the device and the user account, such as the application described in more detail below.

Network-accessible digital content service 102 may further include a catalog engine 116 operatively coupled with the mass storage subsystem 108. For each of the user accounts 110, the catalog engine 116 may be configured to generate a hierarchical tree descriptor for the plurality of digital content items associated with the user account. Such a hierarchical tree descriptor may be an application tree, an XML content tree, etc. that organizes metadata of the digital content items associated with the user account. Such metadata may include, for example in the case of music tracks, artist metadata indicating an artist name of the track, album metadata indicating an album name of an album to which the track corresponds, and track title metadata indicating a title of the track. Further, the hierarchical tree descriptor structures the artist metadata to be superior to the album metadata, and the album metadata to be superior to the track title metadata. For example, in such a music-based context, the hierarchical tree descriptor may be implemented in connection with a menu interface system, in which selection of a particular artist yields a “deeper” sub-menu listing of particular albums by that artist. In turn, selection of a particular album from that artist would yield display of a still deeper sub-menu listing track titles from that album.

In some cases, the catalog engine 116 may be further configured to package the hierarchical tree descriptor into a catalog that is transmittable over network 106 to a portable digital content player device associated with the user account. Such a catalog may be an XML document, and may be of a much smaller size in comparison to the digital content items themselves. In some cases, the catalog may be generated once and stored in cache on the network-accessible digital content service. In some cases, catalog engine 116 and service interface 114 may be collectively referred to as a catalog service 118.

Such a catalog may further include supplemental metadata available to an application on the portable digital content player device upon receipt of the catalog. Such supplemental metadata may include components of an offline store including tracks, banner images, and thumbnails of album artwork of promotional tracks. The supplemental metadata may further include a list of available categories, a list of available full tracks, a catalog version number, and components of an in-application billing system.

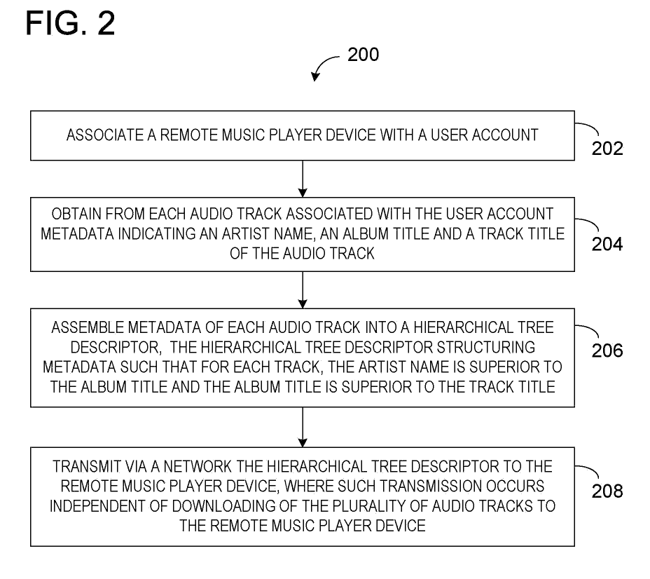

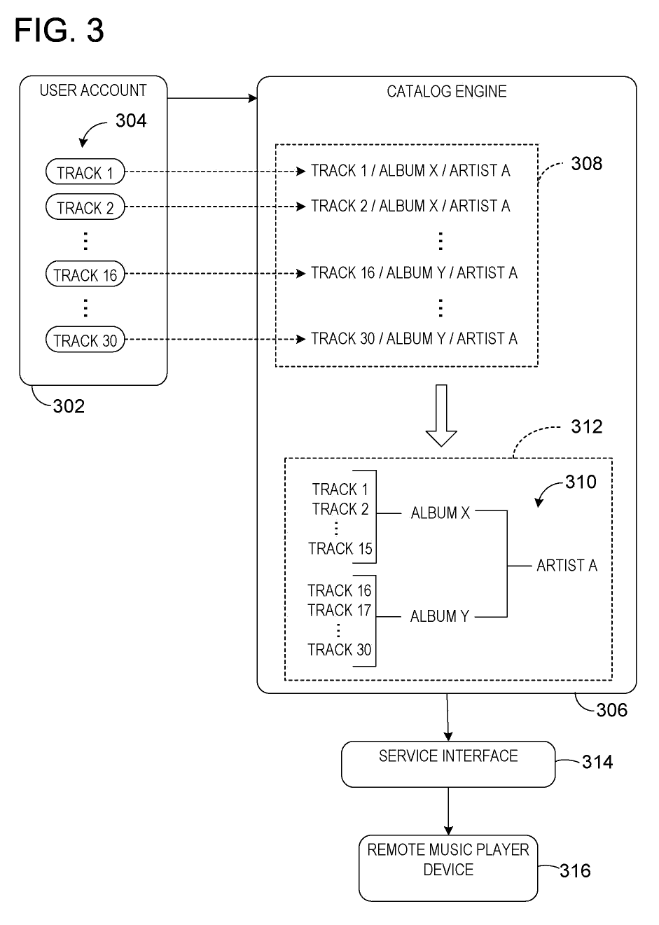

In the context of one portable digital content player device associated with one user account, service interface 114 may cause a transmission of the catalog to the portable digital content player device associated with the user account, where such transmission occurs independent of downloading of the plurality of digital content items to the portable digital content player device. In other words, the catalog including the hierarchical tree descriptor of structured metadata may be sent from network-accessible digital content service 102 to a portable digital content player device, without requiring downloading of the digital content items. Thus, the portable digital content player device may receive the metadata of the digital content items independent from the digital content items themselves. Creation of the hierarchical tree descriptor and transmission of the catalog are described in more detail with reference to FIGS. 2 and 3.

Each portable digital content player device may be further configured to run an application responsive to the catalog, where the application interprets the catalog and provides local searching of the hierarchical tree descriptor in an offline mode. In other words, upon receipt of the catalog including the hierarchical tree descriptor, a user of a portable digital content player device may locally search (i.e. from their portable digital content player device without a network connection) the digital content items located at the network-accessible digital content service associated with their user account. Accordingly, such local searching may have the potential advantage of minimizing client/server exchanges. For example, the user's entire selection of music files (e.g. 1000 music files) may be browsed and searched offline using the local copy of the hierarchical tree descriptor. Any subsequent communication over the network could be deferred until the user selects a track (e.g., by using the tree as a menu interface) that had not yet been downloaded to the user's device.

In one class of examples, the local application may be written in Java and may be handled by the device as a traditional Java MIDlet (Mobile Information Device application). In some cases, the application may be embedded by a handset maker (i.e. during manufacturing). In other cases, the application may be downloaded to the device via a network connection. Furthermore, the application may be implemented to enhance user experience by allowing the user to browse a track music catalog offline, to listen to 30-second previews (by connecting to a web service), and/or to purchase media inside the application or online through an online store.

In some cases, the catalog may have a limited validity period, and the network-accessible digital content service may be configured to generate an updated version of the catalog upon expiration of the limited validity period. Accordingly, the application on the portable digital content player device may be further configured to check for the updated version of the catalog on the network-accessible digital content service via the network. The application may perform such a check in any suitable manner. One such suitable manner includes the application performing a regular check (e.g., during the first network connection after the application launches). The application may store information about the updated version of the catalog, and then at a subsequent launch, display a popup to inform the user of the portable digital content player device that an updated version of the catalog is available. When the user accepts to update the catalog, before the updated version of the catalog is downloaded, the application may call a check URL with an application catalog generation date as a parameter. Such a request is received by the network-accessible digital content service, and in response, the service compares the generation date of the catalog on the device with a generation date of the catalog on the service, and then replies to the application with the suitable download status. Such a check avoids the application re-downloading the same catalog.

The application may be further configured to include an embedded URL pointing to a URL pool, such that the URL pool is loaded upon a first launch of the application. The URL pool may be an XML file containing URLs needed by the application to get, for example, a catalog update, a list of promotional titles and pages, banner images, a preview file, album artwork, etc.

The application may be further configured to provide online searching of an online digital content store at the network-accessible digital content service 102 via the network 106. Such an online digital content store may include a plurality of downloadable digital content items. Such an online store may be a Wireless Access Protocol (WAP) store. In such cases, the URL pool described above may also include URLs needed by the application to obtain a WAP store home URL, a legal terms and conditions WAP page URL, and a full track download URL.

As discussed above, the network-accessible digital content service is configured to generate a hierarchical tree descriptor that structures metadata of digital content items, such as music tracks, associated with a user account of the service, and transmit the hierarchical tree descriptor to the user's portable digital content player device. Accordingly, FIG. 2 shows a method 200 of operating an online music service associated with a plurality of user accounts, where each user account has a plurality of audio tracks. The steps of method 200 as described hereafter reference a user account, and it is to be understood that such a user account may be any of the plurality of user accounts, and therefore, method 200 may be applicable to each of the user accounts. In fact, it will often be desirable to employ the exemplary methods discussed herein in connection with managing an online service having large numbers of user accounts.

At 202, method 200 includes associating a remote music player device with a user account. Nonlimiting examples of a remote music player device may include a mobile phone, a desktop computer, a laptop computer, a portable digital assistant, and the like. As an example, FIG. 3 schematically shows an exemplary user account 302 including a plurality of digital content items 304, schematically depicted as Tracks 1-30.

Returning to FIG. 2, at 204 method 200 includes obtaining, from each audio track associated with the user account, metadata indicating an artist name, an album title and a track title of the audio track. It is to be understood that such metadata is exemplary in that metadata may include any number of track attributes, such as genre, geographic location, release date, etc. As an example, FIG. 3 schematically shows a catalog engine 306, such as catalog engine 116 discussed above with reference to FIG. 1, which obtains metadata 308 from the plurality of tracks 304 associated with user account 302.

Returning to FIG. 2, at 206 method 200 includes assembling metadata of each audio track associated with the user account into a hierarchical tree descriptor. The hierarchical tree descriptor typically structures metadata such that, for each track, the artist name is superior to the album title and the album title is superior to the track title. It is to be understood that metadata may be structured in any other suitable way depending on the nature of metadata. For example, geographic metadata may be superior to genre metadata, and genre metadata may be superior to artist metadata. A variety of hierarchical arrangements are possible in addition to the specifically depicted examples.

In some embodiments, method 200 may further include, upon assembling the metadata into a hierarchical tree descriptor, packaging the hierarchical tree descriptor into a catalog. As described above, such a catalog may be an XML document, and typically is of a much smaller size than the underlying content (e.g., the music track files). As an example, FIG. 3 schematically shows catalog engine 306 assembling a hierarchical tree descriptor 310 structuring the metadata 308 of tracks 304 associated with user account 302. As further shown, catalog engine 306 has packaged hierarchical tree descriptor 310 into a catalog 312.

Returning to FIG. 2, at 208 method 200 includes transmitting via a network the hierarchical tree descriptor to the remote music player device. As previously discussed, the transmission may be performed independent of downloading of the plurality of audio tracks to the remote music player device. As described above, such transmission may be coordinated by a service interface of the online music service. In the case that the hierarchical tree descriptor has been packaged within a catalog, step 208 further includes transmitting the catalog. As an example, FIG. 3 schematically shows a service interface 314 facilitating communications with remote music player device 316 such that catalog 312 containing tree descriptor 310 may be transmitted to remote music player device 316.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A digital content system, comprising:
a network-accessible digital content service, including:
a catalog engine;
a mass storage subsystem operatively coupled with the catalog engine and containing a plurality of user accounts; and
a service interface configured to control communications occurring between the network-accessible digital content service and remote devices which are variously associated with the plurality of user accounts,
where in connection with each of the plurality of user accounts:
the mass storage subsystem contains a plurality of digital content items that are associated with the user account;
the catalog engine generates a hierarchical tree descriptor for the plurality of digital content items and packages the hierarchical tree descriptor into a catalog that is transmittable over a network to a remote device associated with the user account; and
the service interface causes a transmission of the catalog to the remote device associated with the user account, where such transmission occurs independent of downloading of the plurality of digital content items to the remote device.

2. The system of claim 1, where the remote device is further configured to run an application which is responsive to the catalog and operable to provide local searching of the hierarchical tree descriptor in an offline mode.

3. The system of claim 2, where the application is further configured to provide online searching of an online digital content store at the network-accessible digital content service via the network, the online digital content store including a plurality of downloadable digital content items.

4. The system of claim 2, where the catalog further includes supplemental metadata available to the application upon receipt of the catalog.

5. The system of claim 2, where the catalog has a limited validity period, and where the network-accessible digital content service is configured to generate an updated version of the catalog upon expiration of the limited validity period.

6. The system of claim 5, where the application is further configured to check for the updated version of the catalog on the network-accessible digital content service via the network.

7. The system of claim 1, where the digital content items associated with the user account include one or more digital music tracks, each digital music track having metadata including an artist name, an album title and a track title.

8. The system of claim 7, where the hierarchical tree descriptor generated by the catalog engine structures the metadata of each digital music track, such that the artist name is hierarchically superior to the album title, and the album title is hierarchically superior to the track title.

9. An online music system, comprising:
a plurality of user accounts maintained at a network-accessible online music service, where associated with each user account are a plurality of audio track files;
a catalog service operable to provide offline metadata for the plurality of user accounts, whereby, for the plurality of audio track files in each of the plurality of user accounts,
a catalog engine of the catalog service is operable to generate a hierarchical tree descriptor for the plurality of audio track files, such hierarchical tree descriptor including hierarchically-structured artist metadata, album metadata and track title metadata for the plurality of audio track files; and
a service interface of the catalog service is operable to cause network transmission of the hierarchical tree descriptor to a remote music player device associated with the user account.

10. The system of claim 9, where network transmission of the hierarchical tree descriptor to the remote music player device occurs independent of downloading of the plurality of audio track files to the remote music player device.

11. The system of claim 10, where the catalog engine is further configured to package the hierarchical tree descriptor within a catalog, and the service interface is operable to cause network transmission of the catalog to the remote music player device.

12. The system of claim 11, where the remote music player device is further configured to run an application responsive to the catalog, the application being configured to interpret the catalog and provide local searching of the hierarchical tree descriptor in an offline mode.

13. The system of claim 12, where the application on the remote music player device further provides online searching of an online music store via a network connection to the network-accessible online music service, the online music store including a plurality of downloadable audio track files.

14. The system of claim 12, where the catalog has a limited validity period, and where the network-accessible online music service is configured to generate an updated version of the catalog upon expiration of the limited validity period.

15. The system of claim 14, where the application on the remote music player device is further configured to check for the updated version of the catalog on the network-accessible online music service via a network connection.

16. The system of claim 10, where the hierarchical tree descriptor generated by the catalog engine structures the artist metadata to be hierarchically superior to the album metadata, and the album metadata to be hierarchically superior to the track title metadata.

17. A method of operating an online music service associated with a plurality of user accounts, each user account having a plurality of audio tracks, the method comprising, for each of the plurality of user accounts:
associating a remote music player device with the user account;
obtaining, from each audio track associated with the user account, metadata indicating an artist name, an album title and a track title of the audio track;
assembling the metadata of each audio track into a hierarchical tree descriptor, in which artist name metadata is hierarchically superior to album title metadata, and album title metadata is hierarchically superior to track title metadata; and
transmitting, via a network, the hierarchical tree descriptor to the remote music player device, where such transmission occurs independent of downloading of the plurality of audio tracks to the remote music player device.

18. The method of claim 17, where the method further comprises, for each of the plurality of user accounts, periodically updating the hierarchical tree descriptor.

19. The method of claim 18, where periodically updating the hierarchical tree descriptor includes updating the hierarchical tree descriptor upon lapse of a predetermined validity period for the hierarchical tree descriptor.

20. The method of claim 17, where assembling the metadata of each audio track into a hierarchical tree descriptor includes structuring the metadata so that it is usable, by an application running at the remote music player device, to provide metadata searching and track selection in an offline operational mode of the remote music player device.
